(19) United States
(12) Patent Application Publication
(10) Pub. No.: US 2016/0277341 A1
(43) Pub. Date: Sep. 22, 2016

(54) NETWORK COLLABORATION TOOL

(71) Applicant: Micah Garen, Brooklyn, NY (US)

(72) Inventor: Micah Garen, Brooklyn, NY (US)

(21) Appl. No.: 14/740,369

(22) Filed: Jun. 16, 2015

Related U.S. Application Data
(60) Provisional application No. 62/136,090, filed on Mar. 20, 2015.

(51) Int. Cl. H04L 12/58; H04L 29/06; G06F 3/0484

(52) U.S. Cl. CPC H04L 51/16; H04L 51/04; G06F 3/04847; H04L 63/10

(57) ABSTRACT

Computerized collaborative network tools configured to allow users to, inter alia, create, collaborate and/or distribute media content, including video media content. Systems and processes therefor include a workspace component comprising: a media timeline configured to be associated with a media item displayed on a graphic user interface and a discussion component associated with the media timeline. A discussion component can include a commenting component configured to allow a user to create a comment and a time-coding component configured to associate the comment with at least one of a time point or time range in the media timeline.

### CROSS REFERENCE TO RELATED APPLICATIONS

The present application claims priority to U.S. Provisional Patent Application 62/136,090, filed Mar. 20, 2015 and entitled NETWORK VIDEO COLLABORATION TOOL, the entirety of which is incorporated by reference hereby.

### COPYRIGHT NOTICE

A portion of the disclosure of this patent document contains material that is subject to copyright protection. The copyright owner has no objection to the facsimile reproduction by anyone of the patent document or the patent disclosure as it appears in the Patent and Trademark Office patent files or records, but otherwise reserves all copyrights whatsoever.

### SUMMARY

According to embodiments, disclosed are systems, methods, and computer program products comprising a network computer comprising: a transceiver for communicating over a network, a memory that has stored thereon computer executable components, a processor that is operative to execute computer executable components stored in the memory, including a workspace comprising: a media timeline configured to be associated with a media item displayed, for example a video media item, on a graphic user interface; and a discussion component associated with the media timeline.

In embodiments, the discussion component comprises a commenting component configured to allow a user to create a comment, and a time-coding component configured to associate the comment with at least one of a time point or time range in the media timeline. The commenting component can comprise a threading component configured to allow a user to create a threaded commentary within an existing comment.

In embodiments, comment categories can be associated with one or more comments. Comments can further be organized by feature, for example, comment category, user, or time.

In embodiments, one or more users can simultaneously view, edit, comment, or collaborate in real time.

In embodiments, a set of permissions can control a user's access and participation.

### BRIEF DESCRIPTION OF THE DRAWINGS

Embodiments are illustrated in the figures of the accompanying drawings, which are meant to be exemplary and not limiting, and in which like references are intended to refer to like or corresponding things.

FIGS. 1A and 1B show block diagrams of an embodiment of a system architecture for a network collaboration tool.

FIG. 2 shows a block diagram of components of an embodiment of a workspace component.

FIG. 3 shows a block diagram of components of an embodiment of a discussion component.

FIG. 4 shows a block diagram of components of an embodiment of a commenting component.

FIGS. 5-9 show embodiments of creating time-coded commentary.

FIGS. 10-11 show embodiments of comment organization.

FIG. 12 shows an embodiment of threaded commentary.

FIG. 13 shows an embodiment of a client computer.

FIG. 14 shows an embodiment of a network computer.

### DETAILED DESCRIPTION OF THE EMBODIMENTS

Various embodiments now will be described more fully hereinafter with reference to the accompanying drawings, which form a part hereof, and which show, by way of illustration, specific embodiments by which the invention may be practiced. The embodiments may, however, be embodied in many different forms and should not be construed as limited to the embodiments set forth herein; rather, these embodiments are provided so that this disclosure will be thorough and complete, and will fully convey the scope of the embodiments to those skilled in the art. Among other things, the various embodiments may be methods, systems, media, or devices. Accordingly, the various embodiments may take the form of an entirely hardware embodiment, an entirely software embodiment, or an embodiment combining software and hardware aspects. The following detailed description is, therefore, not to be taken in a limiting sense.

Throughout the specification and claims, the following terms take the meanings explicitly associated herein, unless the context clearly dictates otherwise. The term “herein” refers to the specification, claims, and drawings associated with the current application. The phrase “in one embodiment” as used herein does not necessarily refer to the same embodiment, though it may. Furthermore, the phrase “in another embodiment” as used herein does not necessarily refer to a different embodiment, although it may. Thus, as described below, various embodiments of the invention may be readily combined, without departing from the scope or spirit of the invention.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

It is noted that in this disclosure and particularly in the claims and/or paragraphs, terms such as “comprises,” “comprised,” “comprising,” and the like can have the meaning attributed to them in U.S. patent law; that is, they can mean “includes,” “included,” “including,” “including, but not limited to” and the like, and allow for elements not explicitly recited. Terms such as “consisting essentially of” and “consists essentially of” have the meaning ascribed to them in U.S. patent law; that is, they allow for elements not explicitly recited, but exclude elements that are found in the prior art or that affect a basic or novel characteristic of the invention. These and other embodiments are disclosed or are apparent from and encompassed by, the following description. As used in this application, the terms “component” and “system” are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers.

The use of the terms “a,” “an,” “at least one,” “one or more,” and similar terms indicate one of a feature or element as well as more than one of a feature. The use of the term “the” to refer to the feature does not imply only one of the feature and element.

When an ordinal number (such as “first,” “second,” “third,” and so on) is used as an adjective before a term, that ordinal number is used (unless expressly or clearly specified otherwise) merely to indicate a particular feature, such as to distinguish that particular feature from another feature that is described by the same term or by a similar term.

When a single device, article or other product is described herein, more than one device/article (whether or not they cooperate) may alternatively be used in place of the single device/article that is described. Accordingly, the functionality that is described as being possessed by a device may alternatively be possessed by more than one device/article (whether or not they cooperate). Similarly, where more than one device, article or other product is described herein (whether or not they cooperate), a single device/article may alternatively be used in place of the more than one device or article that is described. Accordingly, the various functionality that is described as being possessed by more than one device or article may alternatively be possessed by a single device/article.

The functionality and/or the features of a single device that is described may be alternatively embodied by one or more other devices, which are described but are not explicitly described as having such functionality/features. Thus, other embodiments need not include the described device itself, but rather can include the one or more other devices which would, in those other embodiments, have such functionality/features.

Furthermore, the detailed description describes various embodiments for illustration purposes and embodiments include the methods described and may be implemented using one or more apparatus, such as processing apparatus coupled to electronic media. Embodiments of the present invention may be stored on an electronic media (electronic memory, RAM, ROM, EEPROM) or programmed as computer code (e.g., source code, object code or any suitable programming language) to be executed by one or more processors operating in conjunction with one or more electronic storage media.

Embodiments may be implemented using one or more processing devices, or processing modules. The processing devices, or modules, may be coupled such that portions of the processing and/or data manipulation may be performed at one or more processing devices and shared or transmitted between a plurality of processing devices.

The present invention will now be described in detail on the basis of exemplary embodiments. The invention disclosed herein, may be practiced using programmable digital computers and networks therefor.

Described are embodiments of a computerized collaborative network tools for configured to allow users to, inter alia, create, collaborate and/or distribute media content, including video media content. Embodiments are described in the context of an exemplary, not limiting set of tools and network based user interface, however as will be appreciated, particular embodiments disclosed above are illustrative only, as the invention may be modified and practiced in different but equivalent manners apparent to those skilled in the art having the benefit of the teachings herein. In embodiments, described are a set of network-based tools and an overall ecosystem for content creators and collaborators, from fundraising to collaboration, to distribution. As will be appreciated, while users are described in terms of filmmakers, screeners, and a filmmaking community, embodiments are applicable to any community or users producing, distributing, commenting or otherwise using media such as video-based media content on network platforms.

In embodiments, the system is configured to allow users to join the community, create projects, upload drafts, create teams, invite team members and others to screen the draft, get time-coded comments and feedback on a timeline, and reply in a social media community commenting and screening environment.

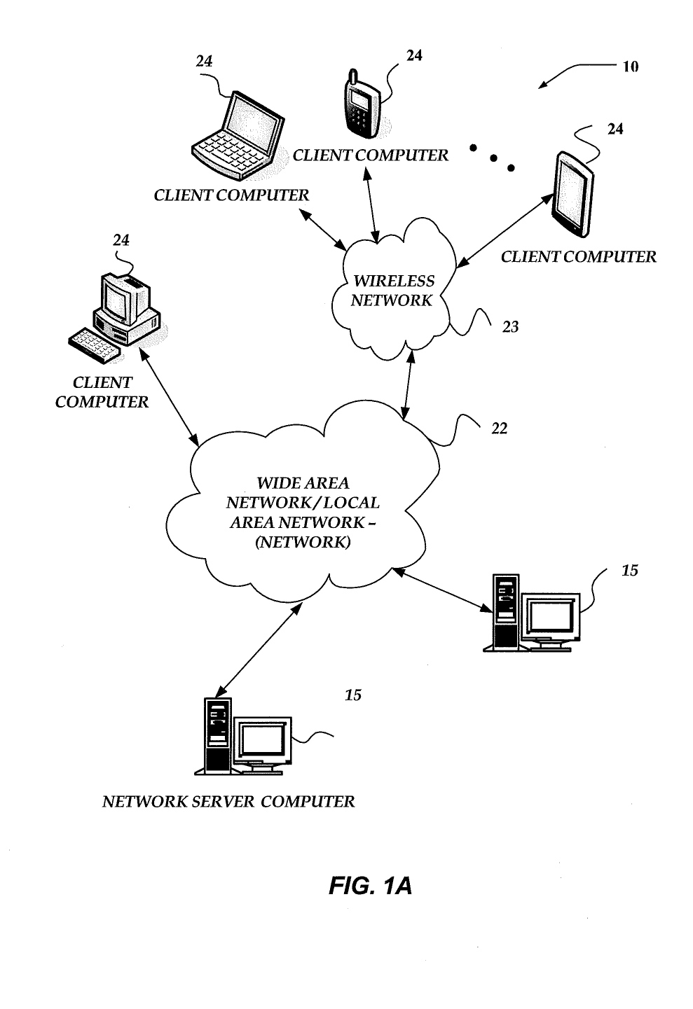

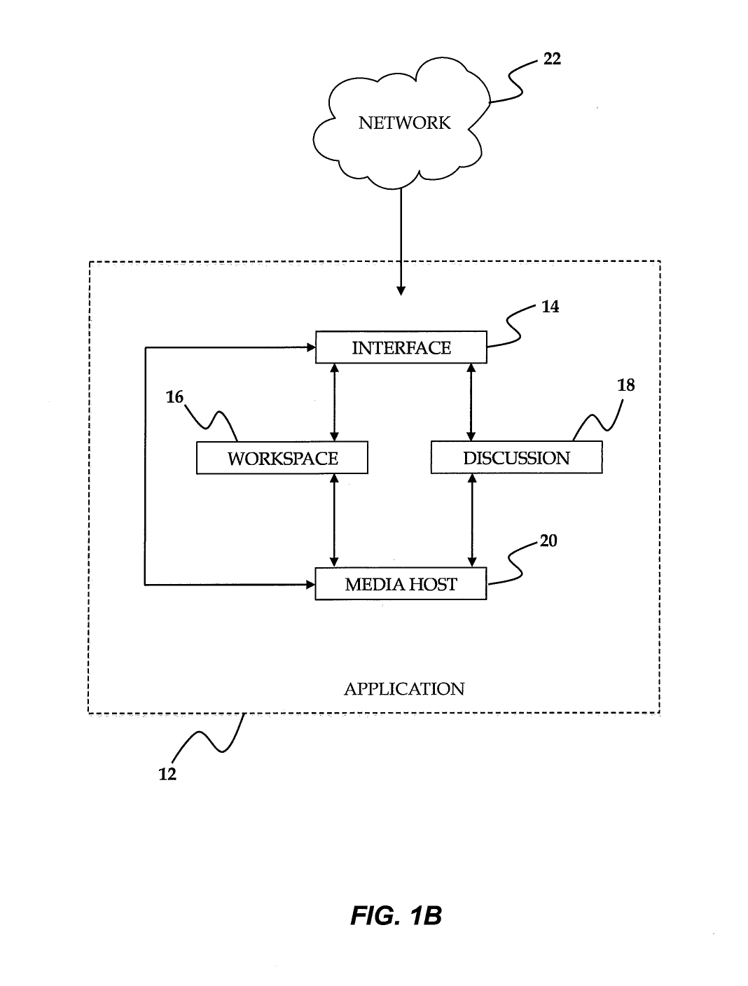

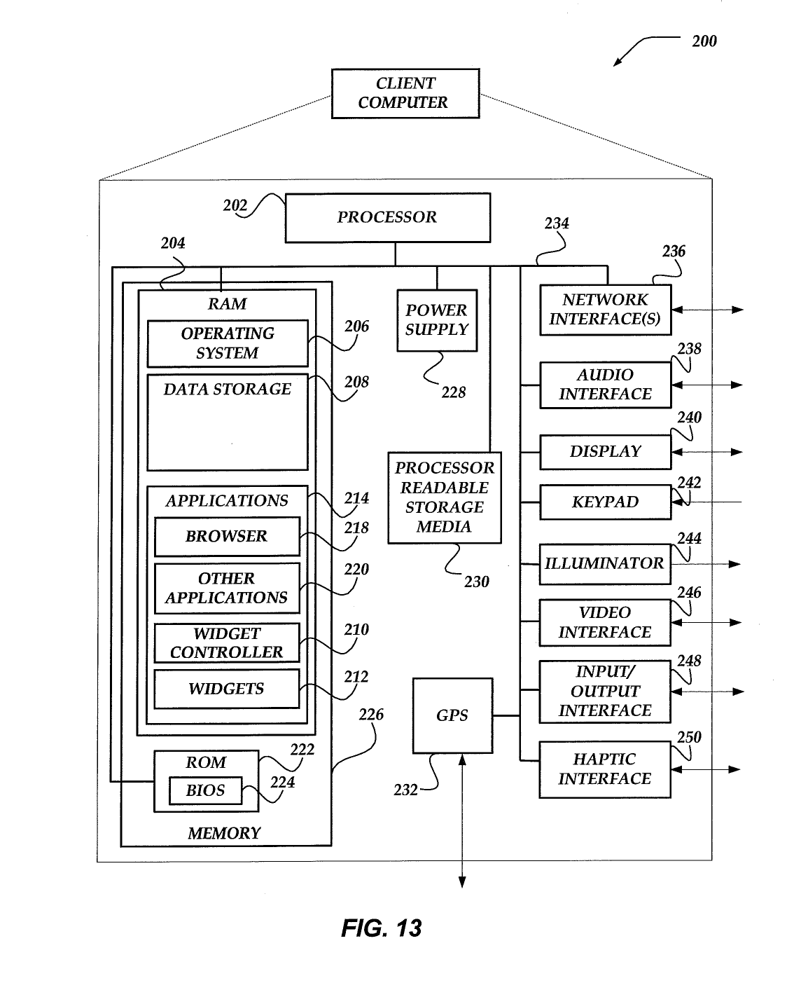

Referring to FIGS. 1A-1B, block diagrams illustrating an embodiment of an exemplary system architecture is shown. System 10 comprises one or more network servers 15 comprising applications that can be accessed by a client device 24 via a network 22. The client device 24 can access the network 22 using, for example, a browser application. The client device 24 is described in more detail with respect to FIG. 13 and can be any of a variety of different computing devices, for example, personal computers, digital assistants, personal digital assistants, cellular phones, mobile phones, smart phones, tablet computers, and laptops. The browser can be any application that allows users of the client 24 to access the network 22. The network 22 can be the Internet, or any combination of a LAN, a MAN, a WAN, a mobile network, a wired or wireless network, a private network, or a virtual private network. For example, a plurality of client devices can be connected by a wireless network 23 with is in turn connected to a network 22 such as a WAN/LAN, or a client device can connect directly to a network 22.

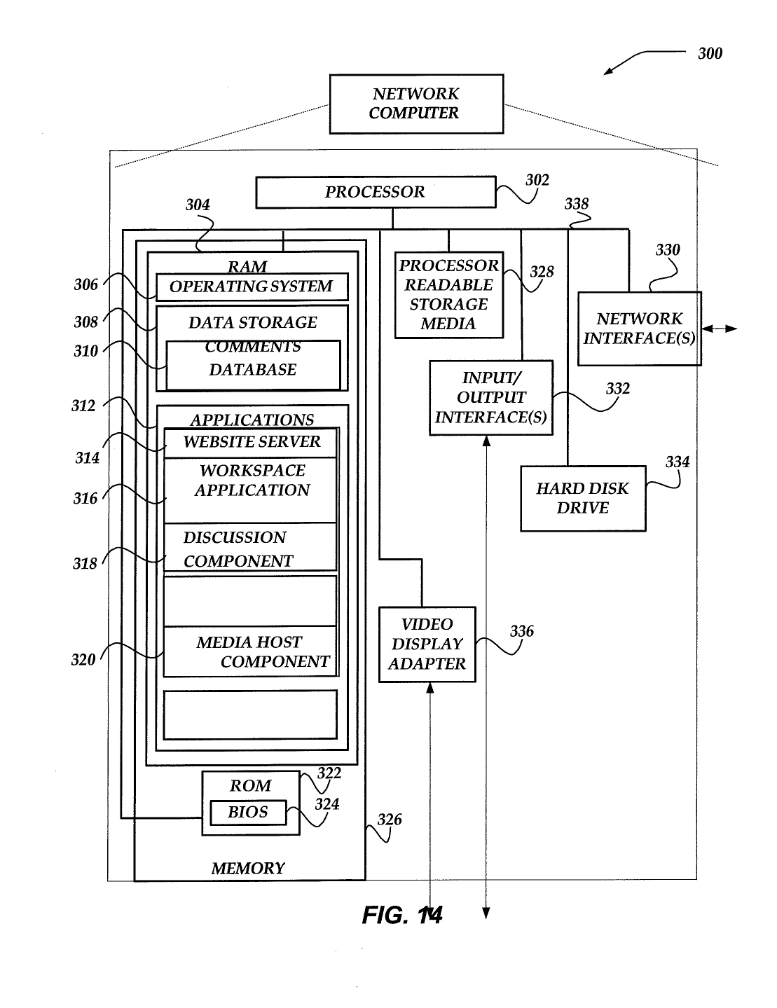

In at least one of the various embodiments, applications 12 may be operative on a Network Server Computer 15 of FIG. 1A, which is described more detail with respect to FIG. 14. Applications 12 may employ processes, or parts of processes, similar to those described herein, to perform at least some of its actions. The applications 12 can include an interface component 14, a workspace component 16, a discussion component 18, and a media host component 20. The interface component 14 can be, for example, a website server component configured to generate an interface that facilitates interaction between a user, via the client device 24, and the applications 12. The interface component 14 is configured allow the user to upload media, including video media, to the media host component 20, which is configured to include storage for optionally storing the upload. The interface 14 is also configured to allow the user to interact with the media via the workspace 16 and discussion 18 components as described herein.

Media can include, inter alia, any media files as known in the art, for example, such as video files and video file formats (e.g., AAF, 3GP, ASF (WMV), AVCHD, DAT, FLV, MPEG-4, MOV, Ogg, SMI, SWV, YUV) and audio media files (e.g. AIFF, FLAG, RAW, MP3, M4A, RA GSM, etc.).

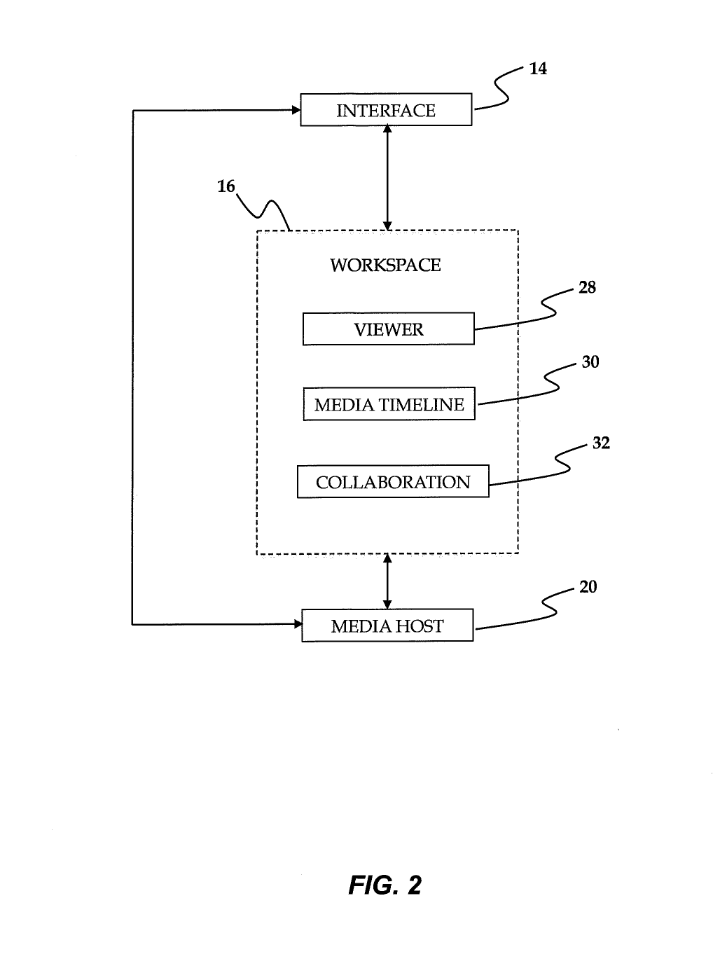

Referring now to FIG. 2, a block diagram illustrating an embodiment of the media workspace 16. The workspace component 16 comprises a viewer component 28, a media timeline 30, and a collaboration component 32.

In an embodiment, workspace 16 is configured to allow a user to view, organize, edit, and share video media, and to interact with other users. Viewer 28 is configured to display video media to a user. Media timeline 30 is configured to associate a timeline with video media items. In an embodiment the media timeline 30 is configured to be visible on a graphic user interface display, although other configurations are possible.

In an embodiment, collaboration component 32 is configured to allow one or more users to view and edit video media. The collaboration component 32 can be configured to allow user actions to occur simultaneously and/or in real time. In embodiments, the collaboration component 32 can be configured to a set of permissions to one or more users. A set of permissions can control a user's access to and participation within the system 10. Exemplary permissions can include, without limitation, uploading media, viewing media, editing media, inviting users, viewing all or a selection of comments, editing comments, creating and deleting comment categories, and managing permissions of users. In an embodiment, each user can be assigned a unique set of permissions. For example, in an embodiment, a user can create a profile that is unique to that user. The profile can be associated with a set of permissions, and a user identifier as discussed herein.

For example, when a user such as a filmmaker creates a project on the network, the user can invite other users, such as “team members,” who have access to a project.

In an embodiment, there can be no limit to the number of team members a filmmaker can invite as part of a project. In embodiments the system can be configured to place limitations or restrictions on invitations and access.

In embodiments, team members can be specific to a project, but can be invited to any number of projects.

In embodiments, team members can be invited and removed by going to “Projects”>“Manage Team Members” and inputting the email(s) of the desired user(s).

In an embodiment, users can receive notifications, for example via email or as a popup on the graphic user interface. Notifications can alert users to any event, for example:
A new invitation to be a user;
A new invitation to view a video;
New threaded discussions and responses to comments.

In an embodiment, conversations are threaded discussions within a comment. conversations appear within a comment, and in a conversations area on the user's graphic user interface.

In an embodiment, a project is a section of an interface that contains and organizes all the drafts, screenings, team members and screeners comments and threaded conversations regarding a video the users are working on as discussed herein. A user can go directly to a “Projects” page from a drop down menu on their profile picture icon or go to “Dashboard”>“Projects”.

In an embodiment, a “Projects” page displays all projects, both projects a user creates and projects for which the filmmaker is a team member.

In embodiments, a filmmaker can remove a project by going to “Projects”>“Edit Project Details”>“Remove Project”

In an embodiment, a draft is a specific video media file within a project. A user can create a new draft by going to “Projects”>“Upload New Draft” and then upload the file to the media storage 20. Multiple drafts can exist within one project.

In an embodiment, a screening is an instance of the draft whereby a user allows other users to view the draft and comment on that draft.

For example, in an embodiment, each user can have different capabilities based on their role, which is determined by the user who invited them. The different roles can include:
Admin: has complete administrative control
Team Member: abilities based on role (e.g. Executive Producer, Producer, Director, Editor, Consulting Editor, Writer, Mentor, Champion, Screener, Marketer, Translator, Transcriber, Musician, Art Director, Animator, Fundraiser, Social Media Outreach, Custom Field)
Screener: has no administrative abilities, can only screen and comment.

In an embodiment, collaboration component 32 includes a conferencing component. The conferencing component can be configured to allow users to share information or media with other users. In an embodiment, conferencing occurs in real time. For example, users can collaborate with others in real time, moving the scroll bar on the timeline, opening comments, and going to specific moments in the cut. Users can open video conferencing windows as they collaborate on discussing a cut.

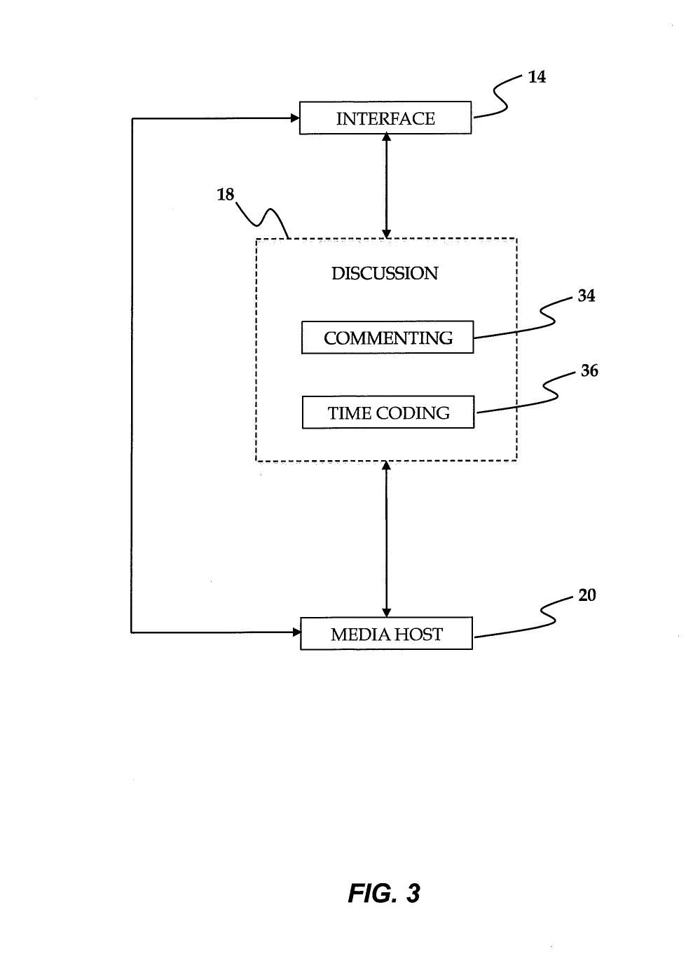

Referring now to FIG. 3, a block diagram illustrating an embodiment of the discussion component 18. Discussion component 18 can include a commenting component 34 and a time coding component 36.

Commenting component 34 is configured to allow a user to create a comment, and time coding component 36 is configured to associate a comment with a time point in the media timeline 30. A user can comment on a specific time-coded moment or time-coded range in the video media item, and that comment can be placed in the media timeline 30 associated with that video media item.

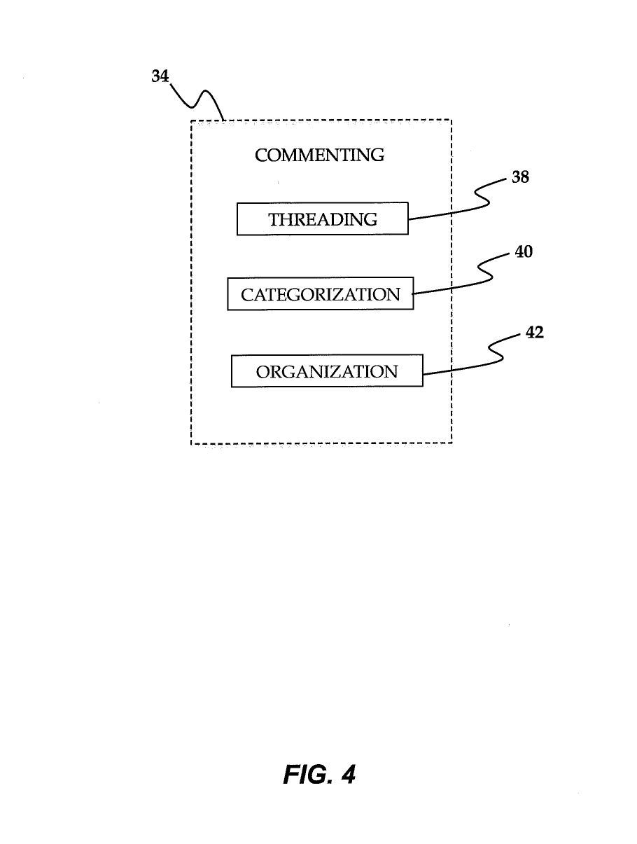

Referring to FIG. 4, a block diagram illustrating an embodiment of the commenting component 34 is shown. In the embodiment, the commenting component 34 further comprises a threading component 38, categorization component 40, and organization component 42.

The categorization component 40 is configured to allow a user to apply categories to comments. Categories can be predetermined by one or more users, or a user can have the option to create a custom category.

In an embodiment, the system is configured to allow a user to select various comment settings. For example, a user can choose a basic commenting setting that allows the user to comment in only one category, such as “general.” In another embodiment, the system can be configured to allow a user can choose an advanced commenting setting that allows the user to place a comment in one or more additional categories, such as for example “story,” “character,” “music,” “narration,” or a custom category.

In an embodiment the system is configured to allow a user to export the comments as a text file.

In an embodiment, the system is configured to allow a user to edit and delete comments, or place an indicator on a comment to show, for example, that the comment has been read or an associated action has been completed.

Generalized Operation

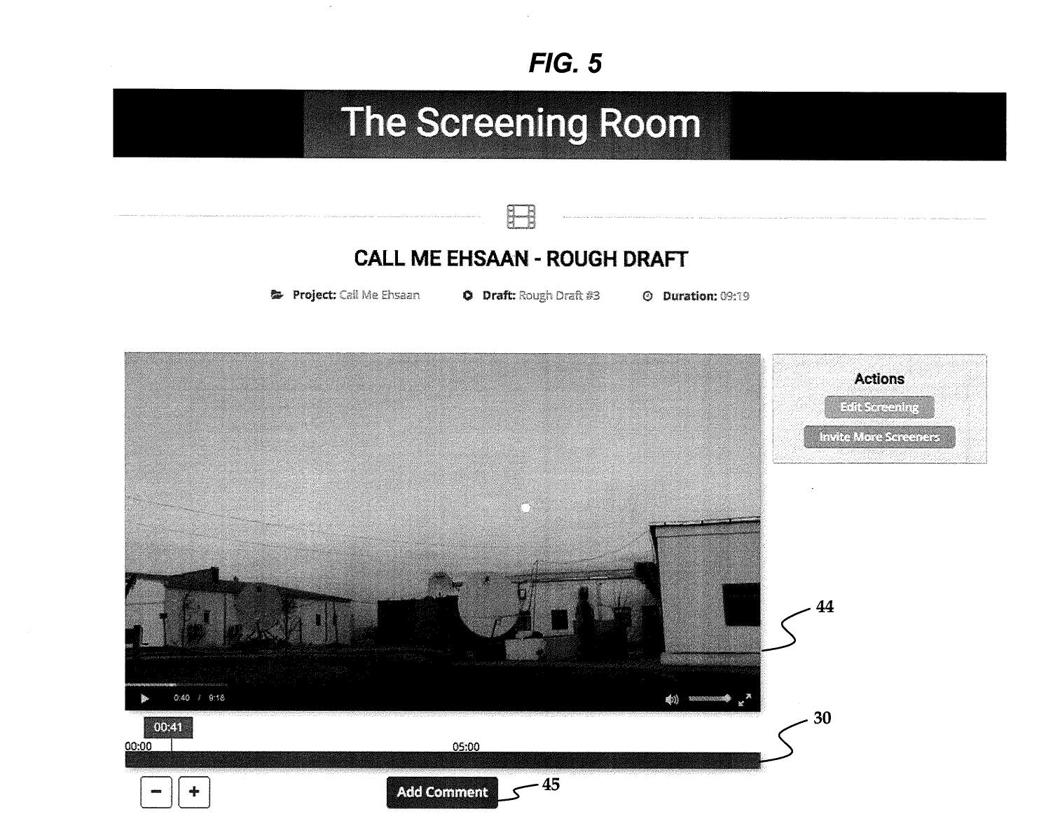

The operation of certain aspects of the invention will now be described with respect to FIGS. 5-12. In at least one of various embodiments, processes described in conjunction with FIGS. 5-12, respectively, may be implemented by and/or executed on a single network computer, such as network computer 15 of FIG. 1A. In other embodiments, these processes or portions of these processes may be implemented by and/or executed on a plurality of network computers, network computers 15 of FIG. 1A. Likewise, in at least one of the various embodiments, processes or portions thereof, may be operative on one or more client computers, such as client device 24. However, embodiments are not so limited, and various combinations of network computers, client devices, virtual machines, or the like may be utilized.

It will be understood that processes can be implemented by computer program instructions. These program instructions may be provided to a processor to produce a machine, such that the instructions, which execute on the processor, create means for implementing the actions specified. The computer program instructions may be executed by a processor to cause a series of operational steps to be performed by the processor to produce a computer-implemented process such that the instructions, which execute on the processor to provide steps for implementing the actions specified. The computer program instructions may also cause at least some of the operational processes to be performed in parallel. Moreover, some of the processes may also be performed across more than one processor, such as might arise in a multi-processor computer system or even a group of multiple computer systems. In addition, one or more processes may also be performed concurrently with other processes, or even in a different sequence than illustrated without departing from the scope or spirit of the invention.

It will also be understood that processes can be implemented by special purpose hardware-based systems, which perform the specified actions or steps, or combinations of special purpose hardware and computer instructions. The foregoing example should not be construed as limiting and/or exhaustive, but rather, an illustrative use case to show an implementation of at least one of the various embodiments of the invention.

Processes are described in terms of embodiments of a use-case interfaces. FIGS. 5-12 represent graphical user interfaces (“GUIs”) for creating and managing commentary with at least one of the various embodiments. In at least one of the various embodiments, user interfaces other than those described may be employed without departing from the spirit and/or scope of the claimed subject matter. Such user interfaces may have more or fewer user interface elements, which may be arranged in various ways. In some embodiments, user interfaces may be generated using web pages and mobile applications.

FIGS. 5-9 show embodiments of a process of creating time-coded commentary associated with a video media item.

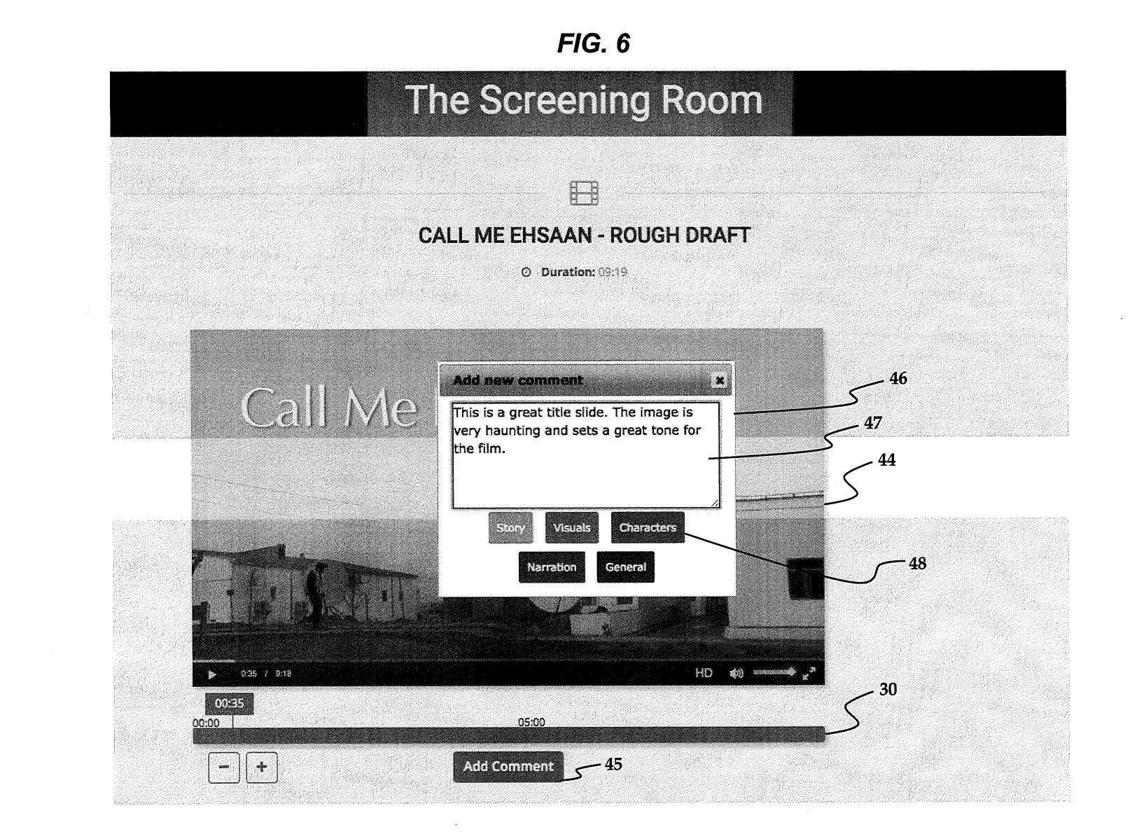

FIG. 5 shows an embodiment of a GUI of a client device displaying a video media item 44, and an associated media timeline 30. In order to create a comment, the system presents the user with an “Add Comment” object 45 on the GUI. When a user selects the “Add Comment” object 45, the system is configured to present the user with an input object 46 for entering the comment, for example a pop-up window for entering a comment, shown in FIG. 6.

FIG. 6 shows a comment input object 46 including a text box 47 where a user can enter text. Also shown are one or more comment categories 48 that the user can select to associate with the comment. For example, in the embodiment shown in FIG. 6, comment categories 48 can include and be selected from “Story,” “Visuals,” “Characters,” “Narration,” and “General.” The comment 46 is time-coded with the media timeline 30. In the embodiment shown in FIG. 6, the comment is coded to a moment in the video at time point 00:35. In various embodiments the system can be configured to automatically stop the video media while the user enters the comment and time-code the comment to that moment. In embodiments the system can be configured to allow the video to keep playing unless manually stopped. The system can also be configured to allow the comment to be time coded to a range (e.g. 00:35-01:55). For example, the system could be configured to time-code a comment from the time it is started until the time the user manually stops the video. The system could also be configured to allow a user to input the time range he or she wants the comment to apply to, for example by allowing a user to mark or scroll beginning and end points on the media-timeline 30.

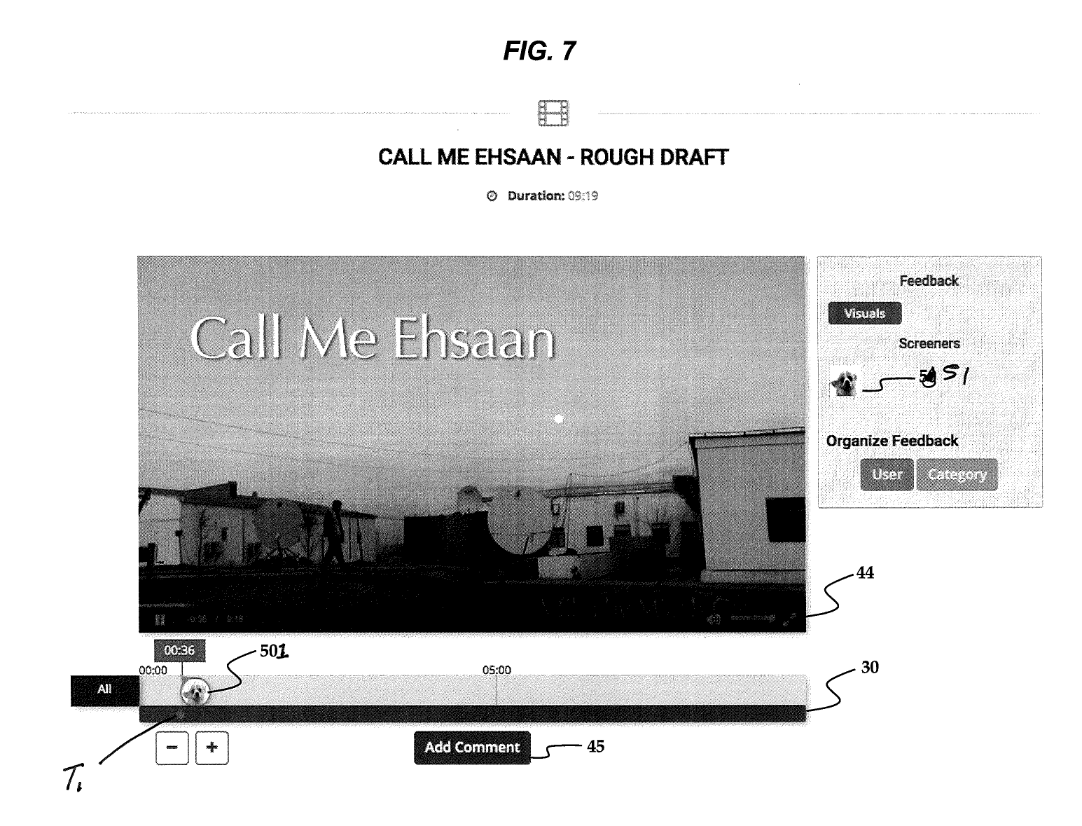

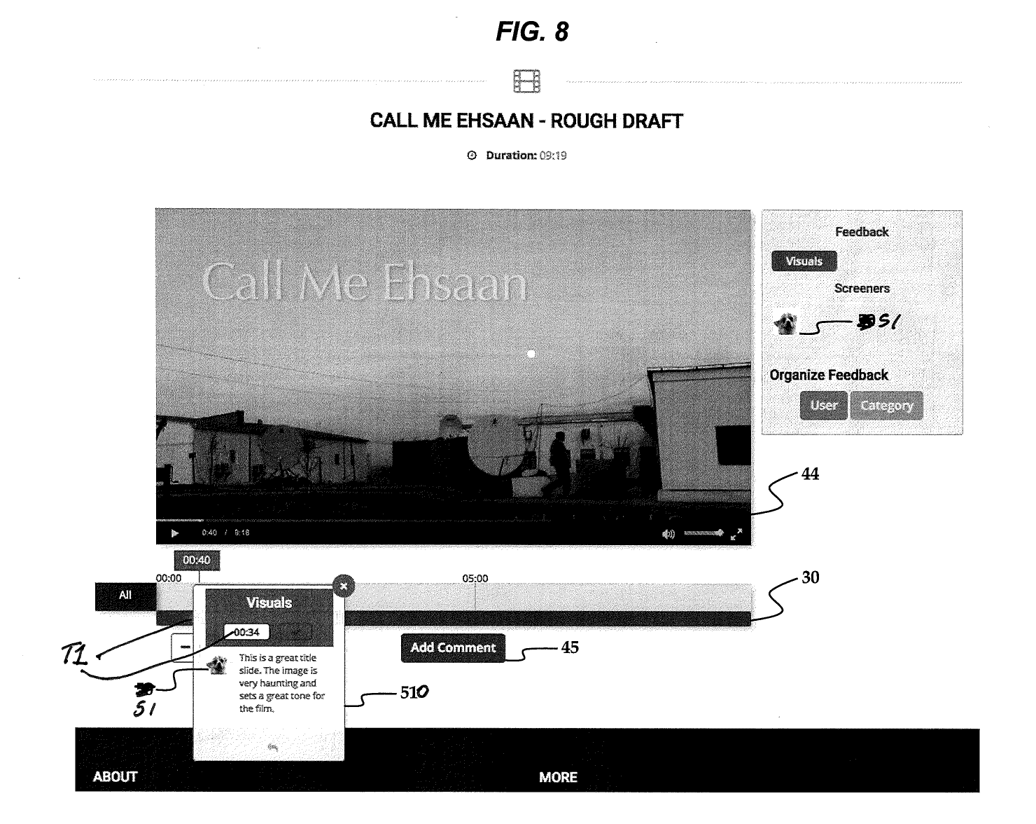

FIG. 7 shows an embodiment wherein a user has created a time-coded comment 501 in the system. In an embodiment, the system is configured to identify a time-coded comment 501 by a user identifier 50 being displayed within the media timeline 30 to indicate the existence of a comment 501 by that user at a specific time point T1. For example, in an embodiment, a user may be identified with a profile, for example when subscribing to the network. As described herein, the user can create a profile, which can be identified with roles or permissions. As shown in FIG. 8, in an embodiment, when that user or another user plays the video, the system can be configured to display an existing comment 501 identified with the user as the media timeline 30 passes the encoded time point T1 or time-range associated with that comment 501, for example, showing the comment in pop-up window 510 together with a user identifier 51 representing that user. The comment object 501 can also include other information, for example the category 48 or categories associated with the comment 501, the timepoint T1 or time range

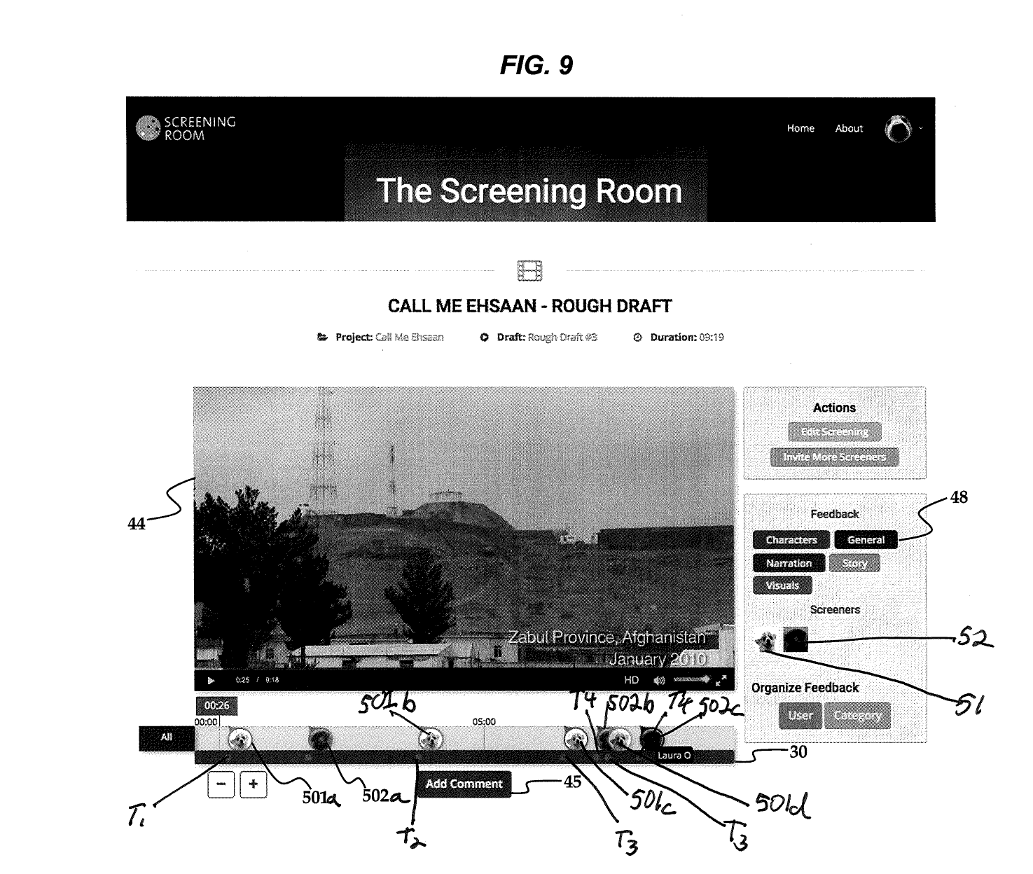

FIG. 9 shows an embodiment wherein a plurality of users 51, 52 have entered several time-coded comments 501, 502. In the embodiment, the system shows a first user's comments 501a, 501b, 501c, 502d and a second user's comments 502a, 502b, 502c, respectively, being displayed within the media timeline 30 to indicate the existence of a comment by that user at specific time points T1, T2, T3, T4, T5, T6, T7. In embodiments any number of users can comment. In embodiments the system can be configured to allow users with appropriate permissions to see other user's comments. As described herein, users can be ascribed roles or permissions. For example, the system can be configured to permit a “project owner” user to view all users' comments for the project owner's media item, whereas other users may only be able to see their own comments or the comments of users' belonging to a predefined class or role. Similarly, the system can be configured to allow user permissions to be defined by other features, for example categories 48. For example, certain users or user classes may not be given permission to see comments associated with the category “Narration,” or “Story” but could see other comments from other categories.

As noted above, an organization component 42 is configured to allow users to organize comments based on one or more features. In an embodiment, features may include category, user, and date.

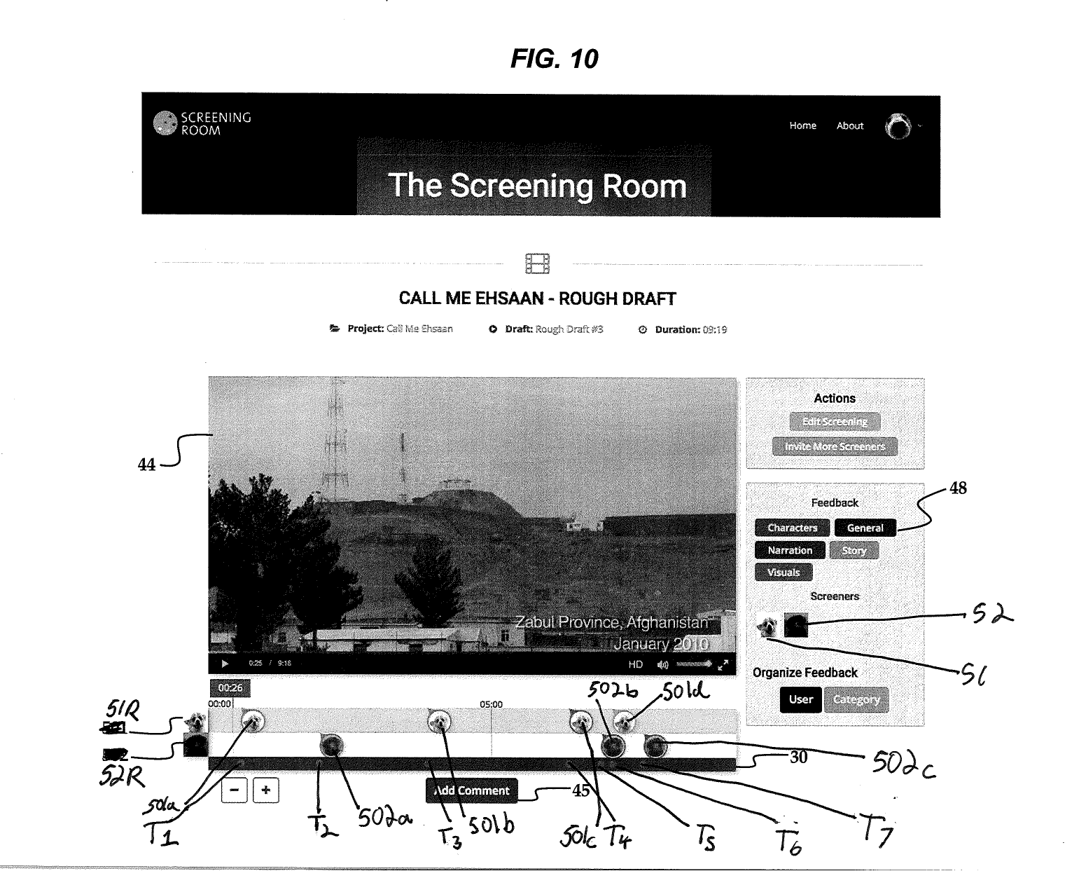

FIG. 10 shows an embodiment wherein comments have been organized by user. In the embodiment shown, comments by each of two users 51, 52 are separated based on the user who created the comment. For example, this is indicated on the GUI by separating comments 501a, 501b, 501c, 502d, 502a, 502b, 502c into organizational rows defined by each of the two users' identifiers 51R, 52R. Each user's comments remain associated with the media timeline 30 time points T1, T2, T3, T4, T5, T6, T7, but are organized by user 51, 52.

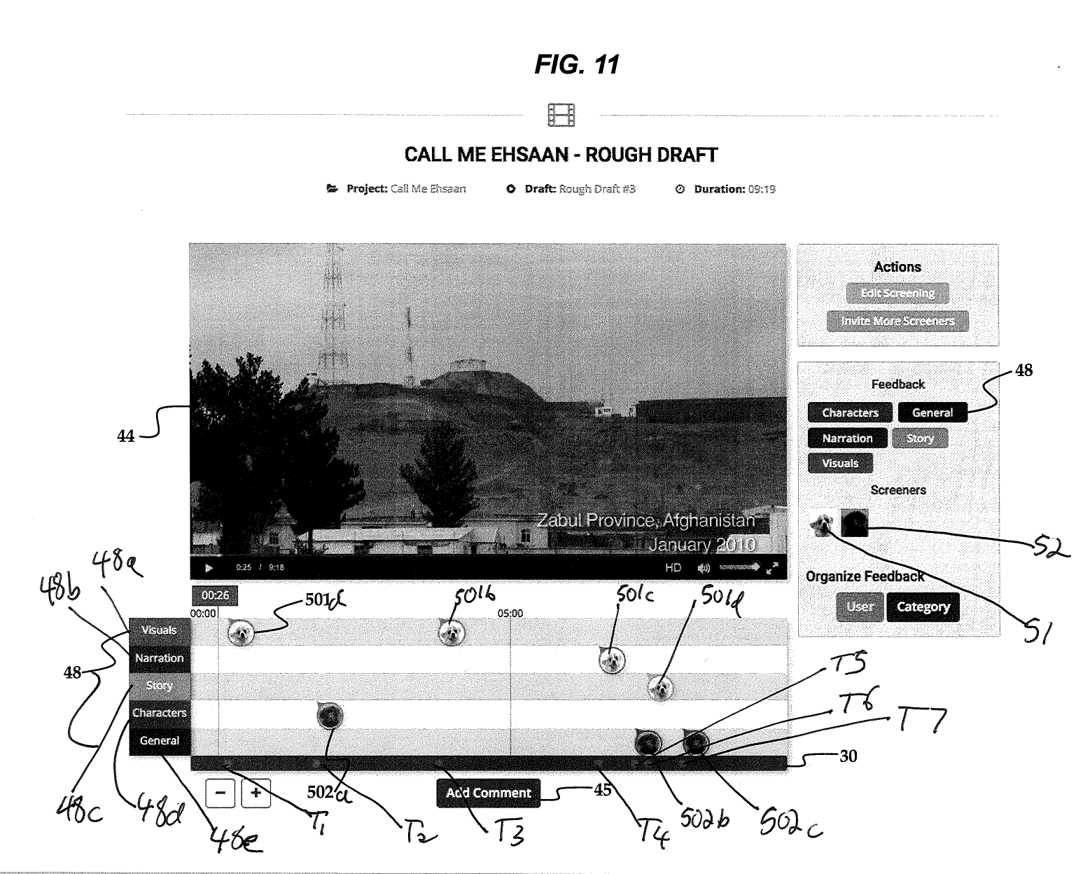

FIG. 11 shows an embodiment wherein comments have been organized by category. In this embodiment, five comment categories 48 have been associated with comments. The time encoded comments 501a, 501b, 501c, 502d, 502a, 502b, 502c have been separated into five organizational rows 48a, 48b, 48c, 48d, 48e, one row for each comment category 48. Examples of categories 48 include “Visuals,” “Narration,” “Story,” “Characters,” and “General.” User identifiers 501a, 501b, 501c, 502d, 502a, 502b, 502 indicate which user has created a comment in a particular category 48. For example, the user associated with identifier 51 has created two comments 501a, 501b, in the “Visuals” category 48a, one comment 501c in the “Narration” category 48b, and one comment 501d in the “Story” category; the user associated with identifier 52 has created one comment 502a in the “Characters” category 48d and two comments 502b, 502c. Each user's comments 501a, 501b, 501c, 502d, 502a, 502b, 502c remain associated with the media timeline 30 time points T1, T2, T3, T4, T5, T6, T7, but are organized by category 48. The organization component 42 can be configured to allow a user to organize comments by sorting, filtering, or any other organization method.

The threading component 38 is configured to allow users to create threaded commentary within existing comments.

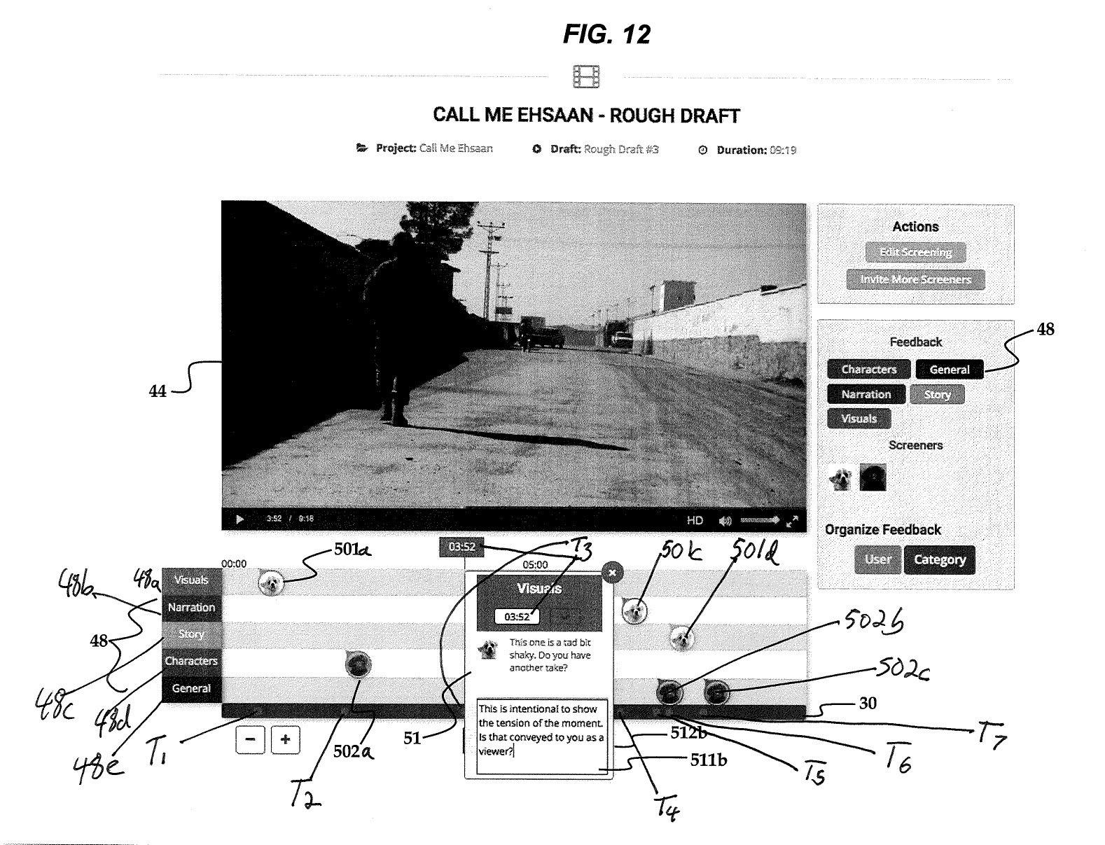

FIG. 12 shows an embodiment wherein a user is creating threaded commentary 52 within an existing time-coded comment object 501. For example, in the embodiment shown, a threaded text box 511b is shown within a comment object 501b, where the same user or a different user can enter text to create a threaded comment 512b. The threaded comment 512b remains associated with the original time-coded comment 501b. The system can be configured to allow users to enter further threaded comments in the comment object 501b so the comment object has a threaded conversation associated with the comment 501b. In embodiments, each user's comments 501a, 501b, 501c, 502d, 502a, 502b, 502c remain associated with the media timeline 30 time points T1, T2, T3, T4, T5, T6, T7 and can include threaded commentary for each time point.

In embodiments, a network video collaboration tool can optionally include the following functionalities.

Fundraising Functionality

PROJECT FUNDING. A user can accept donations for a project from anyone.

SUSTAINING FUNDING. A user can solicit sustaining membership to his work. For example, a user can request that people support their work for $5/month on a sustaining basis, rather than on a project basis.

PRODUCER FUNDING. Producers can join the System and create a project. The Producer can assign that project a budget and upload the full budget or a part of the budget and crowdsource the rest. Once the project has been funded, the producer can solicit interest from filmmakers in the System community. The Producer can award the project and budget to a filmmaker. The Producer will act as a mentor, but once the project is awarded, the budget and creative control can belong to the filmmaker.

Calendar Functionality. The calendar can allow users to create a schedule for a project, setting dates for uploading drafts and upcoming deadlines. A Master calendar within the System with updated deadlines for grants and festivals can be populated in users' calendars as they choose. For example, a user may opt to have upcoming festival deadlines in the U.S. displayed on their personal System calendar. A producer at a network who commissions a film may set a calendar with their team, which includes the filmmaker who got the commission, to have a draft uploaded on a specific date.

Payment Functionality

Subscriptions. The System can operate on a subscription model where users are charged a monthly or yearly fee for access to different System functionalities. The subscriptions can be offered at different levels (e.g. Basic, Premium . . . ). Multiple forms of payment can be accepted, including credit card and bitcoin.

Micro-payments. Micro-payments will be accepted for watching short and long films though payment processing systems, some of which do not charge a processing free for payments under $10.

Archive & Stock Functionality. Users can use the System to put content up quickly and define parameters for licensing. Users can use the System as an archive site for their work. As an example, a user could upload a 5-minute video to the System, set it to ‘public’ and set parameters for usage, these could optionally include:
Free to everyone under the GPLv3 license
Paid licensing

A user can set:
per-second cost
mastering fee
available formats
term of license
territories
platform

A user might choose to upload a 5-minute video and set a per-second licensing fee for worldwide online and television distribution in perpetuity. Then the user could send a link to a watermarked version to networks and interested parties. If anyone wanted to use the material they would simply log into the System and pay the licensing fee to access the material.

Distribution Functionality.

Users can distribute their high-res film through a “download” option or a link with transfer sites to allow a filmmaker to release the final version to a distributor.

Simultaneous Viewing.

Users can set a viewing date and screen their film in real time simultaneously to any number of views. The System can integrate with an app that allows someone to sit in a theater, watch a live screening, and enter comments in the app. The comments will be time-coded to the moment of the film they are watching.

Tickets Functionality.

The ticketing, or box office, functionality of the System can allow people to purchase a certain amount of credit in the System, and use that to watch films on the System. For example, a user can purchase $50 in tickets or credit, and can give 20 $1 tickets to friends to watch one movie and then 10 $3 tickets to friends to watch different movies. The box office functionality can work across any site on the Internet that will accept the System's tickets as a form of payment to watch videos.

Public Screening (Theatre) Functionality.

Public Screenings through the System can be accessible to anyone, even outside of System users.

“Share” Button Functionality.

“Share” is a button in a project where a user can select a draft and decide how the user wants to “share” it. The options for share include:
Publish to the System theatre
Select payment options. For example, micropayments, $3+up (credit card processor and PayPal), or Free.
‘Send to distribution partner’ creates a downloadable link and emails that out—this works for web partners who could simply distribute the HD compressed version.

Producer Functionality.

Producers have the ability to create projects, teams and budgets. Producers can put money into a project. Producers can crowd fund a project.

Mentor Functionality.

A mentor is a System member who acts as a mentor to System filmmakers by providing ongoing feedback on a project.

Star Screener Functionality.

A star screener is a System member who screens multiple films, and is valued for their feedback as a screener.

Follow Functionality.

Follow allows a System user to follow a person or a project and get updates from that person or project.

Exemplary Operating Environment

Embodiments disclosed herein may be practiced using programmable digital computers. An exemplary computer system includes at least one processor, such as an Intel Core™ or Xeon™ microprocessor or a Freescale™ PowerPC™ microprocessor, coupled to a communications channel. The computer system further includes an input device such as, e.g., a keyboard or mouse, an output device such as, e.g., a CRT or LCD display, a communications interface, a data storage device, such as a magnetic disk or an optical disk, and memory such as Random-Access Memory (RAM), each coupled to the communications channel. The communications interface may be coupled to a network such as the Internet.

One skilled in the art will recognize that, data storage devices and memory can be parts of the same unit or units, and that the functions of one can be shared in whole or in part by the other, e.g., as RAM disks, virtual memory, etc. It will also be appreciated that any particular computer may have multiple components of a given type, e.g., processors, input devices, communications interfaces, etc.

The data storage device and/or memory may store an operating system such as Microsoft Windows®, Linux®, Mac OS®, or Unix®. Other programs may be stored instead of or in addition to the operating system. It will be appreciated that a computer system may also be implemented on platforms and operating systems other than those mentioned.

Any operating system or other program, or any part of either, may be written using one or more programming languages such as, e.g., Java®, C, C++, C#, Visual Basic®, VB.NET®, Perl, Ruby, Python, or other programming languages, possibly using object oriented design and/or coding techniques.

One skilled in the art will recognize that the computer system may also include additional components and/or systems, such as network connections, additional memory, additional processors, network interfaces, input/output busses, for example. One skilled in the art will also recognize that the programs and data may be received by and stored in the system in alternative ways. For example, a computer-readable storage medium (CRSM) reader, such as, e.g., a magnetic disk drive, magneto-optical drive, optical disk drive, or flash drive, may be coupled to the communications bus for reading from a computer-readable storage medium (CRSM) such as, e.g., a magnetic disk, a magneto-optical disk, an optical disk, or flash RAM. Accordingly, the computer system may receive programs and/or data via the CRSM reader. Further, it will be appreciated that the term “memory” herein is intended to include various types of suitable data storage media, whether permanent or temporary, including among other things the data storage device, the memory, and the CSRM.

Computer systems may be connected, e.g., in one or more networks, via, e.g., network interfaces. According to an embodiment, the network is, for example, any combination of linked computers, or processing devices, adapted to transfer and process data. The computer network may be private Internet Protocol (IP) networks, as well as public computer networks, such as the Internet that can utilize World Wide Web (www) browsing functionality. The term “the Internet” refers to the worldwide network of interconnected, packet-switched data networks that use the Internet Protocol (IP) to route and transfer data. A client and server on different networks may communicate via the Internet. For example, a workstation may request a World Wide Web file from a Web Server. The Web Server may process the request and pass it to, e.g., an Application Server. The Application Server may then conduct further processing, which may include, for example, sending data to and/or receiving data from one or more other data sources. Such a data source may include, e.g., other servers on the same network or a different one and/or a Database Management System (“DBMS”).

An example of a wired network is a network that uses communication busses and MODEMS, or DSL lines, or a local area network (LAN) or a wide area network (WAN) to transmit and receive data between terminals. An example of a wireless network is a wireless LAN. A cellular network such as Global System for Mobile Communication (GSM) and Enhanced Data rates for GSM Evolution (EDGE) or LTE Advanced is another example of a wireless network. Also, IEEE 802.11 (Wi-Fi) is a commonly used wireless network in computer systems, which enables connection to the Internet or other machines that have Wi-Fi functionality. Wi-Fi networks broadcast radio waves that can be picked up by Wi-Fi receivers that are attached to different computers. Yet, other examples of a wireless network may include a 3G communication network or a 4G communication network. Yet another example of a wireless network is near field communication (NFC)—a set of short-range wireless technologies. NFC typically operated at a distance of 4 cm or less at rates ranging from 106 kbits to 848 kbit/s. NFC involves an initiator that generates an RF field, which in turn powers a passive target. The NFC target can take simple form factors such as tags, stickers, key fobs, or cards that do not require batteries, but can also be used in conjunction with smart cards or phones incorporating NFC functionality.

A network may, for example, connect one or more terminals or clients with each other and with other computer systems, such as file servers or mail servers. The connection may be achieved tangibly, e.g., via Ethernet® or optical cables, or wirelessly, e.g., through use of modulated microwave signals according to the IEEE 802.11 family of standards. A computer system that participates in the network may send data to another computer system in the network via the network connection.

One use of a network is to enable a computer system to provide services to other computer systems, consume services provided by other computer systems, or both. For example, a file server may provide common storage of files for one or more of the computers on a network. A computer sends data including a request for a file to the file server via the network and the file server may respond by sending the data from the file back to the requesting computer.

A network may be connected to one or more other networks, e.g., via a router. A router may also act as a firewall, monitoring and/or restricting the flow of data to and/or from a network as configured to protect the network. A firewall may alternatively be a separate device (not pictured) from the router.

Systems and modules described herein may comprise software, firmware, hardware, or any combination(s) of software, firmware, or hardware suitable for the purposes described herein. Software and other modules may reside on servers, workstations, personal computers, computerized tablets, PDAs, and other devices suitable for the purposes described herein. Software and other modules may be accessible via local memory, via a network, via a browser or other application in an ASP context, or via other means suitable for the purposes described herein. Data structures described herein may comprise computer files, variables, programming arrays, programming structures, or any electronic information storage schemes or methods, or any combinations thereof, suitable for the purposes described herein. User interface elements described herein may comprise elements from graphical user interfaces, command line interfaces, and other interfaces suitable for the purposes described herein. Except to the extent necessary or inherent in the processes themselves, no particular order to steps or stages of methods or processes described in this disclosure, including the Figures, is implied. In many cases the order of process steps may be varied, and various illustrative steps may be combined, altered, or omitted, without changing the purpose, effect or import of the methods described.

It will be appreciated from the above that the invention may be implemented as computer software, which may be supplied on a storage medium or via a transmission medium such as a local-area network or a wide-area network such as the Internet. It is to be further understood that, because some of the constituent system components and method steps depicted in the accompanying Figures and otherwise herein can be implemented in software, the actual connections between the systems components (or the process steps) may differ depending upon the manner in which the present invention is programmed. Given the teachings provided herein, one of ordinary skill in the related art will be able to contemplate these and similar implementations or configurations of the present invention.

It is to be understood that the present invention can be implemented in various forms of hardware, software, firmware, special purpose processes, or a combination thereof. In one embodiment, the present invention can be implemented in software as an application program tangible embodied on a computer readable program storage device.

The application program can be uploaded to, and executed by, a machine comprising any suitable architecture.

Illustrative Client Computer

FIG. 13 shows one embodiment of Client Computer 200 that may be included in a system implementing embodiments of the invention. Client Computer 200 may include many more or less components than those shown in FIG. 13 However, the components shown are sufficient to disclose an illustrative embodiment for practicing the present invention. Client Computer 200 may represent, for example, one embodiment of at least one of Client Computers 102-105 of FIG. 1A.

As shown in the figure, Client Computer 200 includes a processor 202 in communication with a mass memory 226 via a bus 234. In some embodiments, processor 202 may include one or more central processing units (CPU). Client Computer 200 also includes a power supply 228, one or more network interfaces 236, an audio interface 238, a display 240, a keypad 242, an illuminator 244, a video interface 246, an input/output interface 248, a haptic interface 250, and a global positioning system (GPS) receiver 232.

Power supply 228 provides power to Client Computer 200. A rechargeable or non-rechargeable battery may be used to provide power. The power may also be provided by an external power source, such as an alternating current (AC) adapter or a powered docking cradle that supplements and/or recharges a battery.

Client Computer 200 may optionally communicate with a base station (not shown), or directly with another computer. Network interface 236 includes circuitry for coupling Client Computer 200 to one or more networks, and is constructed for use with one or more communication protocols and technologies including, but not limited to, GSM, CDMA, TDMA, GPRS, EDGE, WCDMA, HSDPA, LTE, user datagram protocol (UDP), transmission control protocol/Internet protocol (TCP/IP), short message service (SMS), WAP, ultra wide band (UWB), IEEE 802.16 Worldwide Interoperability for Microwave Access (WiMax), session initiated protocol/real-time transport protocol (SIP/RTP), or any of a variety of other wireless communication protocols. Network interface 236 is sometimes known as a transceiver, transceiving device, or network interface card (NIC).

Audio interface 238 is arranged to produce and receive audio signals such as the sound of a human voice. For example, audio interface 238 may be coupled to a speaker and microphone (not shown) to enable telecommunication with others and/or generate an audio acknowledgement for some action.

Display 240 may be a liquid crystal display (LCD), gas plasma, light emitting diode (LED), organic LED, or any other type of display used with a computer. Display 240 may also include a touch sensitive screen arranged to receive input from an object such as a stylus or a digit from a human hand.

Keypad 242 may comprise any input device arranged to receive input from a user. For example, keypad 242 may include a push button numeric dial, or a keyboard. Keypad 242 may also include command buttons that are associated with selecting and sending images.

Illuminator 244 may provide a status indication and/or provide light. Illuminator 244 may remain active for specific periods of time or in response to events. For example, when illuminator 244 is active, it may backlight the buttons on keypad 242 and stay on while the Client Computer is powered. Also, illuminator 244 may backlight these buttons in various patterns when particular actions are performed, such as dialing another client computer. Illuminator 244 may also cause light sources positioned within a transparent or translucent case of the client computer to illuminate in response to actions.

Video interface 246 is arranged to capture video images, such as a still photo, a video segment, an infrared video, or the like. For example, video interface 246 may be coupled to a digital video camera, a web-camera, or the like. Video interface 246 may comprise a lens, an image sensor, and other electronics. Image sensors may include a complementary metal-oxide-semiconductor (CMOS) integrated circuit, charge-coupled device (CCD), or any other integrated circuit for sensing light.

Client computer 200 also comprises input/output interface 248 for communicating with external devices, such as a headset, or other input or output devices not shown in FIG. 2. Input/output interface 248 can utilize one or more communication technologies, such as USB, infrared, Bluetooth™, or the like.

Haptic interface 250 is arranged to provide tactile feedback to a user of the client computer. For example, the haptic interface 250 may be employed to vibrate client computer 200 in a particular way when another user of a computing computer is calling. In some embodiments, haptic interface 250 may be optional.

Client computer 200 may also include GPS transceiver 232 to determine the physical coordinates of client computer 200 on the surface of the Earth. GPS transceiver 232, in some embodiments, may be optional. GPS transceiver 232 typically outputs a location as latitude and longitude values. However, GPS transceiver 232 can also employ other geo-positioning mechanisms, including, but not limited to, triangulation, assisted GPS (AGPS), Enhanced Observed Time Difference (E-OTD), Cell Identifier (CI), Service Area Identifier (SAI), Enhanced Timing Advance (ETA), Base Station Subsystem (BSS), or the like, to further determine the physical location of client computer 200 on the surface of the Earth. It is understood that under different conditions, GPS transceiver 232 can determine a physical location within millimeters for client computer 200; and in other cases, the determined physical location may be less precise, such as within a meter or significantly greater distances. In one embodiment, however, client computer 200 may through other components, provide other information that may be employed to determine a physical location of the computer, including for example, a Media Access Control (MAC) address, IP address, or the like.

Mass memory 226 includes a Random Access Memory (RAM) 204, a Read-only Memory (ROM) 222, and other storage means. Mass memory 226 illustrates an example of computer readable storage media (devices) for storage of information such as computer readable instructions, data structures, program modules or other data. Mass memory 226 stores a basic input/output system (BIOS) 224 for controlling low-level operation of client computer 200. The mass memory also stores an operating system 206 for controlling the operation of client computer 200. It will be appreciated that this component may include a general-purpose operating system such as a version of UNIX, or LINUX™, or a specialized client communication operating system such as Microsoft Corporation's Windows Mobile™, Apple Corporation's iOS™, Google Corporation's Android™ or the Symbian® operating system. The operating system may include, or interface with a Java virtual machine module that enables control of hardware components and/or operating system operations via Java application programs.

Mass memory 226 further includes one or more data storage 208, which can be utilized by client computer 200 to store, among other things, applications 214 and/or other data. For example, data storage 208 may also be employed to store information that describes various capabilities of client computer 200. The information may then be provided to another computer based on any of a variety of events, including being sent as part of a header during a communication, sent upon request, or the like. Data storage 208 may also be employed to store social networking information including address books, buddy lists, aliases, user profile information, or the like. Further, data storage 208 may also store message, we page content, or any of a variety of user generated content. At least a portion of the information may also be stored on another component of client computer 200, including, but not limited to processor readable storage media 230, a disk drive or other computer readable storage devices (not shown) within client computer 200.

Processor readable storage media 230 may include volatile, nonvolatile, removable, and non-removable media implemented in any method or technology for storage of information, such as computer- or processor-readable instructions, data structures, program modules, or other data. Examples of computer readable storage media include RAM, ROM, Electrically Erasable Programmable Read-only Memory (EEPROM), flash memory or other memory technology, Compact Disc Read-only Memory (CD-ROM), digital versatile disks (DVD) or other optical storage, magnetic cassettes, magnetic tape, magnetic disk storage or other magnetic storage devices, or any other physical medium which can be used to store the desired information and which can be accessed by a computer. Processor readable storage media 230 may also be referred to herein as computer readable storage media and/or computer readable storage device.

Applications 214 may include computer executable instructions which, when executed by client computer 200, transmit, receive, and/or otherwise process network data. Network data may include, but is not limited to, messages (e.g. SMS, Multimedia Message Service (MMS), instant message (IM), email, and/or other messages), audio, video, and enable telecommunication with another user of another client computer. Applications 214 may include, for example, browser 218, and other applications 220. Other applications 220 may include, but are not limited to, calendars, search programs, email clients, IM applications, SMS applications, voice over Internet Protocol (VOIP) applications, contact managers, task managers, transcoders, database programs, word processing programs, security applications, spreadsheet programs, games, search programs, and so forth.

Browser 218 may include virtually any application configured to receive and display graphics, text, multimedia, messages, and the like, employing virtually any web based language. In one embodiment, the browser application is enabled to employ HDML, WML, WMLScript, JavaScript, SGML, HTML, XML, and the like, to display and send a message. However, any of a variety of other web-based programming languages may be employed. In one embodiment, browser 218 may enable a user of client computer 200 to communicate with another network computer, such Network Computer 300 of FIG. 14.

Applications 214 may also include Widget Controller 210 and one or more Widgets 212. Widgets 212 may be collections of content provided to the client computer by Content Delivery Server Computer 112. Widget Controller 210 may be a program that may be provided to the client computer by Content Delivery Server Computer 113. Widget Controller 210 and Widgets 212 may run as native client computer applications or they may run in Browser 218 as web browser based applications. Also, Widget Controller 210 and Widgets 212 may be arranged to run as native applications or web browser applications, or combination thereof.

Illustrative Network Computer

FIG. 14 shows one embodiment of a network computer 300, according to one embodiment of the invention. Network computer 300 may include many more or less components than those shown. The components shown, however, are sufficient to disclose an illustrative embodiment for practicing the invention. Network computer 300 may be configured to operate as a server, client, peer, a host, or any other computer. Network computer 300 may represent, for example the Network Sever of FIG. 1, and/or other network computers.

Network computer 300 includes processor 302, processor readable storage media 328, network interface unit 330, an input/output interface 332, hard disk drive 334, video display adapter 336, and memory 326, all in communication with each other via bus 338. In some embodiments, processor 302 may include one or more central processing units.

As illustrated in FIG. 14, network computer 300 also can communicate with the Internet, or some other communications network, via network interface unit 330, which is constructed for use with various communication protocols including the TCP/IP protocol. Network interface unit 330 is sometimes known as a transceiver, transceiving device, or network interface card (NIC).

Network computer 300 also comprises input/output interface 332 for communicating with external devices, such as a keyboard, or other input or output devices not shown in FIG. 14. Input/output interface 332 can utilize one or more communication technologies, such as USB, infrared, Bluetooth™, or the like.

Memory 326 generally includes RAM 304, ROM 322 and one or more permanent mass storage devices, such as hard disk drive 334, tape drive, optical drive, and/or floppy disk drive. Memory 326 stores operating system 306 for controlling the operation of network computer 300. Any general-purpose operating system may be employed. Basic input/output system (BIOS) 324 is also provided for controlling the low-level operation of network computer 300.

Although illustrated separately, memory 326 may include processor readable storage media 328. Processor readable storage media 328 may be referred to and/or include computer readable media, computer readable storage media, and/or processor readable storage device. Processor readable storage media 328 may include volatile, nonvolatile, removable, and non-removable media implemented in any method or technology for storage of information, such as computer readable instructions, data structures, program modules, or other data. Examples of processor readable storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other media which can be used to store the desired information and which can be accessed by a computer.

Memory 326 further includes one or more data storage 308, which can be utilized by network computer 300 to store, among other things, applications 314 and/or other data such as content 310. For example, data storage 308 may also be employed to store information that describes various capabilities of network computer 300. The information may then be provided to another computer based on any of a variety of events, including being sent as part of a header during a communication, sent upon request, or the like. Data storage 308 may also be employed to store messages, web page content, or the like. At least a portion of the information may also be stored on another component of network computer 300, including, but not limited to processor readable storage media 328, hard disk drive 334, or other computer readable storage medias (not shown) within client computer 300.

Data storage 308 may include a database, text, spreadsheet, folder, file, or the like, that may be configured to maintain and store user account identifiers, user profiles, email addresses, IM addresses, and/or other network addresses; or the like.

In at least one of the various embodiments, Data storage 308 may include a comment database 310, which may contain comments for one or more users or media items. Comment database 310 may include historical information for user as well as comment information associated with the system (e.g., categories, user, time-coding, ect.).

Data storage 308 may further include program code, data, algorithms, and the like, for use by a processor, such as processor 302 to execute and perform actions. In one embodiment, at least some of data store 308 might also be stored on another component of network computer 300, including, but not limited to processor-readable storage media 328, hard disk drive 334, or the like.

Applications 312 may include computer executable instructions, which may be loaded into mass memory and run on operating system 306. Examples of application programs may include transcoders, schedulers, calendars, database programs, word processing programs, Hypertext Transfer Protocol (HTTP) programs, customizable user interface programs, IPSec applications, encryption programs, security programs, SMS message servers, IM message servers, email servers, account managers, and so forth. Applications 312 can also include website server 314, Workspace Application 316, Discussion Component 318, and Media Host Component 319 as described herein.

Website server 314 may represents any of a variety of information and services that are configured to provide content, including messages, over a network to another computer. Thus, website server 314 can include, for example, a web server, a File Transfer Protocol (FTP) server, a database server, a content server, or the like. Website server 314 may provide the content including messages over the network using any of a variety of formats including, but not limited to WAP, HDML, WML, SGML, HTML, XML, Compact HTML (cHTML), Extensible HTML (xHTML), or the like. As explained herein with respect to FIG. 1A, 14, website server component 314 can be configured to generate an interface that facilitates interaction between a user, via the client device and the applications 312. The interface component 314 is configured allow the user to upload media, including video media, to the media host component 320, which is configured to include storage for optionally storing the upload. The interface 314 is also configured to allow the user to interact with the media via the workspace 316 and discussion 318 components as described herein.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Although illustrative embodiments of the invention have been described in detail herein, it is to be understood that the invention is not limited to those precise embodiments, and that various changes and modifications can be effected therein by one skilled in the art without departing from the scope and spirit of the invention.

What is claimed is:

1. A network computer comprising
a transceiver for communicating over a network;
a memory that has stored thereon computer executable components;
a processor that is operative to execute computer executable components stored in the memory, including:
a workspace component comprising:
a media timeline configured to be associated with a media item displayed on a graphic user interface; and
a discussion component associated with the media timeline.

2. The network computer of claim 1, the discussion component comprising:
a commenting component configured to allow a user to create a comment; and
a time-coding component configured to associate the comment with at least one of a time point or time range in the media timeline.

3. The network computer of claim 2, the commenting component further comprising:
a threading component configured to allow a user to create a threaded commentary within an existing comment.

4. The network computer of claim 2, the commenting component further comprising:
a categorization component configured to allow a user to create one or more comment categories associated with one or more comments.

5. The network computer of claim 2, the commenting component further comprising:
an organization component configured to organize comments by one or more features.

6. The network computer of claim 5, wherein the features include at least one of a comment category, user, or time.

7. The network computer of claim 1, the workspace component further comprising:
a collaboration component configured to allow one or more users to view and optionally edit the media item.

8. The network computer of claim 7, wherein the collaboration component is configured to allow one or more users to simultaneously view, edit, or comment in real time.

9. The network computer of claim 7, the collaboration component further comprising a conferencing component.

10. The network computer of claim 7, wherein the collaboration component is configured to assign one or more users a set of permissions that controls a user's access and participation.

11. A system for collaboration over a network, comprising:
a network computer comprising
a transceiver for communicating over the network;
a memory that has stored thereon computer executable components;
a processor that is operative to execute computer executable components stored in the memory, including,
a workspace component comprising,
a media timeline configured to be associated with a media item displayed on the graphic user interface; and
a discussion component associated with the media timeline comprising,
a commenting component configured to allow a user to create a comment, including one or more of
a threading component configured to allows a user to create a threaded commentary within existing comments;
a categorization component configured to allow a user to create one or more comment categories associated with one or more comments;
an organization component configured to organize comments by one or more features; and
a time-coding component configured to associate the comment with at least one of a time point or time range in the media timeline.

12. A method being performed by a computer system that comprises one or more processors, a memory operatively coupled to at least one of the processors, and a computer-readable storage medium encoded with components executable by at least one of the processors and operatively coupled to at least one of the processors, the method comprising:
presenting, via a workspace component, a media timeline configured to be associated with a media item displayed on a graphic user interface;
presenting, via a discussion component,
a commenting object configured to allow a user to create a comment; and
associating the comment with at least one of a time point or time range in the media timeline.

13. The method of claim 12, further comprising:
presenting a threading input to allow a user to create a threaded commentary within an existing comment.

14. The method of claim 12, further comprising:
presenting a categorization component configured to allow a user to associate one or more comment categories with one or more comments.

15. The method of claim 12, further comprising:
presenting an organization component configured to allow a user to organize comments by one or more features.

16. The method of claim 15, wherein the features include at least one of a comment category, user, or time.

17. The method of claim 12, further comprising:
allowing one or more users to view and optionally edit the media item.

18. The method of claim 17, further comprising:
allowing one or more users to simultaneously view, edit, or comment in real time.

19. The method of claim 12, further comprising:
allowing one or more users to assign as set of permissions that controls a user's access and participation within the system.
